(19) United States
(12) Patent Application Publication
(10) Pub. No.: US 2008/0020364 A1
(43) Pub. Date: Jan. 24, 2008

(54) Web-based learning suite and method for its use

(75) Inventors: John M. Wattendorf, Alexandria, VA (US); Eam Man, Laramie, WY (US); Rachel Mohammed, Woburn, MA (US); Sandeep Pandia, Acworth, GA (US); David H. Tai, Wesley Chapel, FL (US); Matthew G. Valencius, Quincy, MA (US); Nancy J. Lewis, Pleasantville, NY (US)

Correspondence Address: CAHN & SAMUELS, LLP, 1100 17th STREET, NW, SUITE 401, WASHINGTON, DC, 20036, US

(73) Assignee: International business machines corporation, Armonk, NY (US)

(21) Appl. No.: 11/489,551

(22) Filed: Jul. 20, 2006

(51) Int. Cl. G09B 3/00

(52) U.S. Cl. 434/322

(57) ABSTRACT

A method and system for providing integrated learning materials to a learner within an organization. The learning materials are generated by subject matter experts and compiled in a database on a server. The learning materials are organized corresponding to at least one topic into learning suites and further organized into nodes that provide the learners with different contextual bases and modalities with respect to the compiled materials.

### FIELD OF THE INVENTION

The present invention generally relates to a Web-enabled method of providing learning materials to individuals, i.e., “learners”, who have access to the Internet and who desire to increase their knowledge and competence in a particular area or areas. More particularly, the present invention is directed to a method and system by which learners can access “learning suites” of related information regarding a particular topic where the information includes up-to-date and extensive educational materials using the Internet. The information content accessed by the learners is managed to provide an efficient learning experience to the learner and is tailored to his or her specific desired topic and level of expertise with respect to the topic.

### BACKGROUND OF THE INVENTION

In accordance with related-art methods of learning, individuals interested in personal development and learning related to a particular topic of interest are required to cull through many different informational sources, such as distant learning assets, organizational libraries, course listings and other sources of learning material available in an organization, to discover all the material, support, and developmental suggestions available. For example, with respect to career-related learning for individuals within a certain organization, members of the organization typically must randomly search large amounts of varied material available to the organizational members. Upon gathering an abundance of potentially relevant information, the learner must then filter the specific information he or she believes is most relevant to the particular issue he or she wishes to learn about. This causes an undue waste of time and often does not result in the learner accessing and/or reviewing the most relevant information in order to most efficiently provide the learner with the needed information.

Additionally, individuals responsible for the design, development, deployment and maintenance of related-art learning methods and their associated materials currently fail to efficiently provide holistic, integrated and synergistic support to a potential learner. This is due at least in part to the fact that no straightforward method exists for accessing and viewing all, or at least the most relevant, of the collected available content as an integrated whole.

Employees in large organizations often have a wide range of learning resources available to help them learn to fulfill their assigned roles and accomplish organizational goals effectively and efficiently. However, knowing where to find the precise content needed with the appropriate level of support is a daunting endeavor. In the on-demand era, the ability to shift learning from the classroom to the workplace is a competitive advantage. However, the need to provide easily located and readily available learning resources to be able to accomplish such work-based learning is difficult. No tool that provides such organization of resources and ready access to content and support is known to be available. Additionally, because of the size, complexity and global scope of multi-national corporations, the sheer volume of required learning resources creates an enormous challenge for learning specialists tasked with maintaining currency of the related learning materials. To help address these challenges, the inventors created an innovative framework of on-line learning resources organized as “learning suites.” These learning suites are designed to leverage opportunities for work-enabled learning and to enhance both ease of access for users and clear ownership of content by subject matter experts.

### SUMMARY OF THE INVENTION

Illustrative, non-limiting embodiments of the present invention address the aforementioned and other disadvantages associated with related art methods of learning. Also, it is noted that the present invention is not necessarily required to overcome the disadvantages described above.

In accordance with one exemplary embodiment, a method of providing informational content to a user is provided, the method comprising compiling a database on a server, wherein the database includes informational content relevant to each of a plurality of different topics, selecting a particular topic from the plurality of topics, selecting a node from a plurality of nodes corresponding to the selected topic, wherein each of the plurality of nodes provides access to informational content on the database from a different contextual basis, and providing informational content associated with the selected node to the user.

According to a further exemplary embodiment of the invention, a system for providing information about a particular topic to a user is provided. The system comprises, a database operably connected to the world-wide-web and including informational content related to various topics, an interface device operable to send and receive data from the database, means for selecting, on the interface device, the particular topic from a plurality of available topics presented to the user on the interface device, means for selecting a node from a plurality of nodes associated with the selected topic, wherein each node corresponds to different informational content related to the selected topic and the informational content corresponding to each node is from a different contextual basis, and means for determining a learning level associated with the user, wherein the informational content associated with the selected node is different depending on the learning level of the user.

According to a further exemplary embodiment of the invention, a computer program product for providing informational content to a user is provided. The program product comprises a computer readable medium, first program instruction means for interfacing with a database on a server, wherein the database includes informational content relevant to each of a plurality of different topics. The program product further includes, second program instruction means for enabling a particular topic from the plurality of topics, third program instruction means for enabling a node from a plurality of nodes corresponding to the enabled topic, wherein each of the plurality of nodes provides access to informational content on the database from a different contextual basis, and fourth program instruction means for providing informational content associated with the enabled node to the user.

### BRIEF DESCRIPTION OF THE FIGURES

FIG. 1 is a conceptual illustration of a learning suite in accordance with the invention.

FIG. 2 is a block diagram illustrating a system for implementing a learning suite in accordance with the present invention.

### DETAILED DESCRIPTION OF EXEMPLARY EMBODIMENTS

Exemplary, non-limiting, embodiments of the present invention are discussed in detail below. While specific configurations and process flows are discussed to provide a clear understanding of the invention, it should be understood that the disclosed process flows and configurations are provided for illustration purposes only. A person skilled in the relevant art will recognize that other process flows and configurations may be used without departing from the spirit and scope of the invention.

More particularly, the potential range of topics for which learning can be obtained in accordance with the invention is virtually unlimited. That is, any topic for which information can be made available via the Internet is capable of being learned in accordance with the present invention. However, in accordance with one embodiment, some organizations will likely limit, or at least focus, the available topics to those that are deemed important to enabling learners to achieve the organization's goals and those topics that are sufficiently important to warrant the comprehensive learning solution enabled by a particular learning suite as described in the detailed description below.

An embodiment consistent with the present invention comprises both an organizational framework and an online learning tool that encourages workplace learning and promotes easy identification and access to learning resources and support that is related to a specific topic. For example, in the case of “LEADing@IBM,” which is one of IBM's programs for providing leadership enablement and development, each relevant grouping of available topics, that is, each “learning suite,” represents a broadly defined leadership topic and the variety of learning resources available to the learner related to that topic.

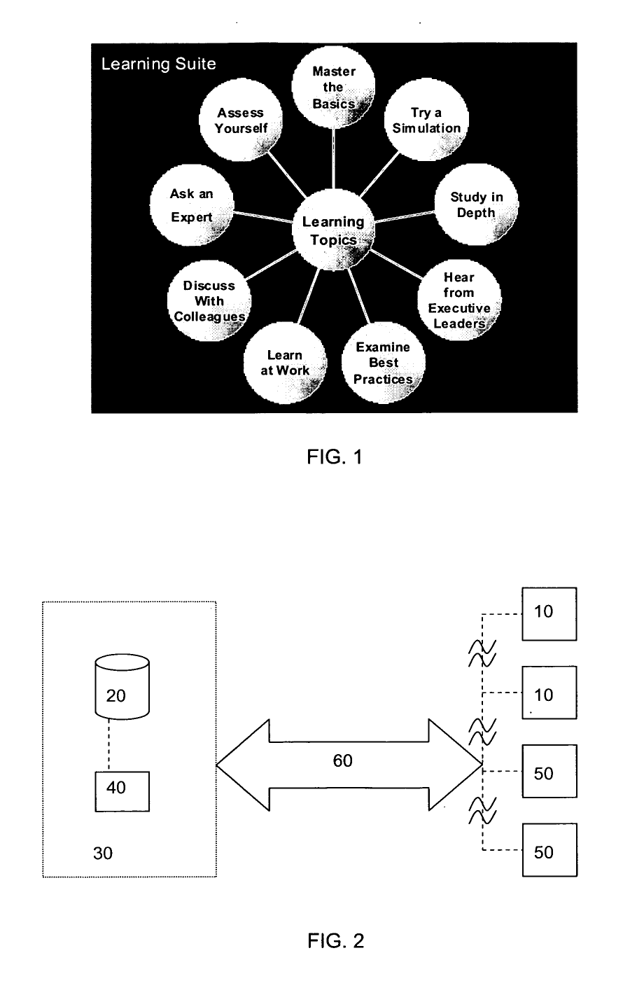

As illustrated in FIG. 1, according to one embodiment the topics for which learning materials are available to a learner are expressed as tasks that a leader must perform to be effective, or, in some cases, as more generic proficiencies expressed as leadership competencies or managerial styles. Exemplary topics might include tasks such as running a meeting, conducting a negotiation and resolving a conflict. Exemplary competencies might include client partnering and strategic risk taking.

Further, consistent with the invention, exemplary embodiments organize learning around specific areas of interest to the learner and assist in focusing developmental efforts. As used herein, the variety of related learning resources is organized as a learning suite. In one embodiment, each suite includes at least one of the following learning nodes provided in a consistent, familiar format so that the learner can quickly and easily access content and support for the level and type of learning required to meet his or her individual requirements. The following is a non-exhaustive exemplary list of nodes that a learner can access consistent with this embodiment:

Master the Basics: This node provides the learner with an opportunity to learn the fundamentals of the particular topic.

Try a Simulation: This node provides the learner with an opportunity to test his or her capability with respect to the particular topic in a virtual and risk-free environment.

Study in Depth: This node provides the learner with an opportunity to explore and learn about the particular topic at a deeper level.

Hear from Executive Leaders: This node provides the learner with an opportunity to learn what senior leaders who are experts have to say about the particular topic.

Examine Best Practices: This node provides the learner with an opportunity to learn how and what other people who have demonstrated mastery of the particular topic are actually performing on-the-job relative to the topic.

Learn at Work: This node provides the learner with an opportunity to learn how to leverage workplace experiences to gain proficiency related to the particular topic.

Discuss with Colleagues: This node provides the learner with an opportunity to share experiences and lessons learned with other persons engaged in learning about the particular topic.

Ask an Expert: This node provides the learner with an opportunity to get questions answered by an expert with respect to the subject matter of the particular topic.

Assess Yourself: This node provides the learner with an opportunity to find out how well he or she understands the particular topic.

In accordance with at least one embodiment of the invention, the latest Web-enabled technology, discussed herein below, is utilized providing the learner with easy access to all of the learning resources and support available on a given topic in a simple, replicable format that provides a consistent, easy-to-use, just-in-time approach to learning.

That is, an advantage gained in accordance with the present invention is that is saves a learner time in bringing together, in one place, all the essential and most effective learning experiences for a particular learning topic, such as a specific leadership competency. Furthermore, the invention provides additional advantages with respect to current professional development practices. These advantages include, but are not limited to, enforcing the practice of “trusted source” for content management, for each of the nodes individually, and for all of the content that makes up the topic of that suite.

That is, learning content can be created and used from several different sources across an enterprise, and also from outside the enterprise. Each learning suite deliberately houses and creates links and RSS feeds to specific learning content and sources to develop a specific competency. This learning resource and content selection, housed and referenced within a learning suite, creates the trusted source for the standards of excellence, practices and approaches the enterprise approves, and even requires, for developing a specific competency.

Each learning suite “pulls” into its construct content from expert portfolios located across the enterprise based on specific content tagging schemes. This ensures, (a) the content being used is “best practice,” expert-vetted and deemed essential for building the capability, and, (b) a content management approach is created that minimizes redundant content for a particular topic within the suite.

As mentioned above, each learning suite uses content tagging schemes to offer deeper personalization of content to different job roles—by selected functions and management role. Content is “tagged” so that a topical learning suite can serve up content more relevant to a specific role. Learning suite content is also tagged based on modality and type of learning. For example, the exemplary learning suite mentioned above has nine different nodes. Learning content and resources are tagged so that they are housed in the correct node of the learning suite.

The third major advantage of the invention is the new comprehensive instructional design construct required by learning design and developers. By having to populate the individual nodes on a suite, the instructional design (ID) construct expands a developer's thinking on how to build capability. Further, instead of a traditional ID construct including asking for the content for just educational nodes, the learning suite ID construct makes the developer solve for assessment, education, strategic alignment, work-based development, best practice and expert access and collaborative learning; thereby, raising the effectiveness of the entire design and development process.

Another significant advantage with respect to the invention is the productivity gain afforded by a learning suite. The learning suite is a repeatable and scalable professional development approach and learning asset that can make both learners and development communities highly productive. Learners will become familiar with the construct of the suite and by using it for many of their development needs the learner will get better and faster at using it and not waste time, for example, on learning several different e-learning navigation methods as is required currently. Additionally, subject matter experts (SMEs) are better able to supply content in a more usable format that will enhance the content quality of learning suites across the enterprise.

Learning developers are able to, (a) benefit from have best practice ID approaches and expectations built into the learning suite design so a company will be able to use less experienced, lower cost developers to create a variety of learning suites; (b) best ID practices will continually be added to future releases of the learning suite for everyone to use—this will continually raise the effectiveness of the suite itself and facilitate best learning suite practices across the entire ID community, and; (c) having a consistent construct and pervasively used approach to professional development will enhance the ability of ID teams (both internal, external and mixed) to come together and produce, e.g., more rapid development.

An exemplary embodiment with respect to a learning suite according to the present invention will now be described.

A learning suite consists of at least one learning node, each representing a different level or modality of learning. The nodes allow the learner to access precisely the level and type of material that is most relevant to his or her personal learning requirements. In accordance with a further embodiment, for example when addressing leadership competencies, a user selects a role-appropriate view of a learning node in order to further personalize and focus the learning. Thus, a senior executive and first-line manager will have access to different content related to the same general competency in order to address the needs of their particular roles. Because the learning suite is a Web-enabled tool, it is available to the learner anytime and anyplace. Use of the Web allows learning suite developers to provide links from any of the nodes to other relevant content to enhance the learning experience.

The following is a more detailed description of various nodes in accordance with the embodiment of the invention mentioned above.

Master the Basics—this is the learning node of choice if a person wants basic information about the topic. For instance, this is often the starting place for first-time use of a learning suite. This is also the node of choice for a person who wants to learn how to do something or learn more about a particular topic quickly. For example, a manager who needs to plan an important meeting may want to review tips for conducting an effective meeting. In this case, a link to an appropriate “QuickView” (an online resource summarizing foundational material about a given topic) provides the best material with respect to the topic, as well as the ability to print checklists and related tools to help the manager succeed. In some cases the learning topic will be closely related to other learning topics. In fact, learning with respect one topic may require the learner to first obtain mastery of some other topic. In such cases, the links to other supporting topics will reside at this node. As an example, to master the leadership competency “Developing People and Communities” one must gain some proficiency at coaching. Thus, the coaching learning suite will be found as a link at the Master the Basics node of the Developing People and Communities learning suite. This node is populated for every suite.

Try a Simulation—at this node the learner is invited to experience the topic, or a specific task related to the topic, in a safe, virtual environment where practice and feedback are risk-free with no negative consequences. For example, in the coaching learning suite, a manager may select the Try a Simulation node and link directly to a scenario-driven simulator that includes realistic coaching situations with many possible outcomes, depending upon chosen actions. The simulator gives the manager the opportunity to test his or her skill using the organization's approach to coaching and to create a development plan focused on areas where improvement is suggested and desired. For some topics, for example those addressing formal human resource policies and programs, less complex simulations called “QuickCases” are available to test one's knowledge and identify possible shortcomings where further development is warranted. This node may or may not be populated for a given suite depending upon whether a simulation is an effective way to learn about the topic.

Study in Depth—at this node the learner can explore the topic in greater depth by linking to reference materials representing the best thinking from practitioners, researchers and academics as expressed in writings from the world's best business schools, as well as from the business and popular press. Book summaries are provided as well as easy access to ways to purchase a book if desired. The latest information about the topic can be made available using a Really Simple Syndication (RSS) feed. RSS is a format that aggregates content from external web sites to display summary information or “headlines” for specified topics. If there are formal classes offered on the topic, these may be referenced at this node as well. Whenever content is available to a learner who wants to explore the topic in more depth, this node will include a link to such information.

Hear from Executive Leaders—at this node the learner can explore what selected senior leaders in the organization have to say about this topic. This node differs from the “Examine Best Practices” node described immediately below, as follows. For example, in accordance with the present node, i.e., Hear From The Executive Leaders, an regarding the topic “Strategy,” an interview with the Senior Vice President might be provided that discusses the organization's business strategy. In contrast, an example from the “Explore Best Practices” node might provide information with respect to a manager doing something especially effective, and perhaps out of the ordinary, to help his or her team understand how their work fits into the overall strategy.

Examine Best Practices—at this node the learner has the opportunity to see what high performing organizational members, and possibly even employees in other organizations, are actually doing relevant to the particular topic. In short, this is a repository for “best practices.” Best practices may be described as stories or simply as actions taken.

Learn At Work—at this node the learner will find a variety of recommended workplace learning activities that can be tried on-the-job to provide practice and promote learning related to this suite topic. Essentially, this node provides suggestions about how to leverage the workplace to enhance learning. One or both of observational and experiential learning are included at this node.

Some of these activities may be prescribed as part of the assigned learning related to a given phase of a course or a leadership development initiative. For example, a work-enabled learning assignment using the “PARR” approach, described below, may include one or more of these activities. PARR is IBM's copyrighted four-step approach to optimize learning from workplace experiences. The following discussion describes the PARR framework:

P=Prepare. The preparation phase:

1. Clarifies learning topic and focus (the “what”).

2. Relates the topic to achieving business results for the organization (the “why”).

3. Assigns knowledge and comprehension-level learning to prepare for work-enabled learning activity (initiates the “how” completed in the following 3 phases).

A=Act (Learning Activity). The Activity phase:

1. Assigns an activity that leverages the workplace to enhance learning.

2. Capitalizes on observational and/or experiential learning in the workplace.

3. Includes guidance to focus learning for effectiveness (quality) and efficiency (cost).

R=Reflect. The reflect phase:

1. Guides learner through a structured after-action review to enhance and embed learning by answering questions organized into four categories:

a. What happened? Record in your journal the relevant facts related to the activity. State what happened and the outcomes you observed. Think of yourself as a reporter capturing just the facts. Do not do any analysis or express any opinions at this step. Do record the relevant, important facts as you see them.

b. Why did it happen? Consider your description of what happened and record in your journal your explanation for any Leadership Areas of Interest (LAI)—surprises or significant actions and outcomes, anything you want to explore further. Your challenge is to explain, to account for LAI's.

c. What did I learn? Record in your journal any significant insights or lessons learned that you will want to remember and use in the future.

d. What will I do? Record actions that you plan to take relative to this learning. You might include activities to enhance your learning as well as actions to apply what you have already learned to improve your performance at work.

2. Captures essence of activity and learning insights in a personal journal

R=Review. The review phase:

1. Requires learner to explore results of first 3 phases with another person (coach/teacher).

2. Helps learner clarify thinking and explore ways to further enhance and embed learning.

Other activities will be optional suggestions for those desiring to develop skill in this specific area. In many cases the activity recommends that the learner's manager be engaged to provide feedback and coaching. An underlying principle that guides on-demand learning is that a key responsibility of a leader is to help develop the next generation of leaders at every level in the organizational hierarchy. An organization's bench strength, e.g., its ability to rely on other members of the organization when the main individual responsible for a given task is otherwise unable to perform that task, depends upon leaders developing leaders. Thus, like a strong emphasis on work-enabled learning, “leaders teaching leaders” is a fundamental principle of all learning integrated into the design of learning suites.

Discuss with Colleagues—at this node the learner can join discussions with other learners and share observations and experiences related to this topic. The idea is to create learning communities and leverage the organization's intellectual capital. Ideally, this node will include both a synchronous and an asynchronous capability.

Ask an Expert—at this node the learner has the opportunity to pose a question to a suite topic subject matter expert. Again, the learning node takes advantage of the unique capabilities of the Internet and Web-enabled learning. Building upon the advantages of working in different time zones around the globe, multi-national companies can provide access to experts around the clock. By capitalizing on expert tracking systems, learners using this node will be able to see who is online at any point in time and ready to answer their questions. Additionally, by keeping track of frequently asked questions, it is possible to build a repository of responses to the most common issues facing learners and provide immediate answers without the need for human intervention.

Assess Yourself—at this node, the learner has the opportunity to take a quiz to assess his or her understanding of the topic. Additionally, when appropriate, the learner may complete a self-assessment instrument, for example, a competency self assessment. The purpose of these activities is to learn what one does or does not know about the topic to guide further learning.

A description of a particular embodiment of the invention and how it is implemented is set forth below.

A learning suite in accordance with the invention utilizes a computer server at its core and individual users, i.e., learners, access a particular suite as they would any other website on the web. For example, a server such as IBM's Lotus Domino server can be used. Lotus Domino is an IBM server product that provides enterprise-grade e-mail, collaboration capabilities and custom application platform. Domino began life as Lotus Notes Server, the server component of Lotus Development Corporation's client-server messaging technology. More particularly, a Lotus Domino server can be used as an application server for Lotus Notes applications and/or as a web server.

With respect to the core server, e.g., Lotus Domino, three tiers of technology to support the learning suite are provided. Specifically, the content for the learning suite is stored in a database, such as a Lotus Notes database, on the server. Further, the server dynamically renders HTML and JavaScript to present the user interface. That is, the core server generates the necessary interface so the individual learners can access the content from their remote workstation or computer connected to the Internet. Lastly, the authoring component of the learning suite takes places via a Lotus Notes client.

Learning suites are designed so that either technical and/or non-technical content authors create rich-text content without needing to be familiar with html or other technologies. The core HTML of the suite website is contained in editable configuration documents. This allows the site user interface (UI) and functionality to be adjusted via simple edits rather than via application code changes once it is deployed on a server. This reduces the amount of information technology (IT) support needed for each suite.

It should also be noted that other technologies, such as Flash, can also be used to make components of the learning suite more interactive. Flash refers to both the Macromedia Flash Player and to a multimedia authoring program used to create content for it as well as games or movies created using the program.

Unique JavaScript libraries are created to make learning content available to other Web pages and devices. Using these libraries, learning content and links to the learning suite website can be rendered dynamically on external websites or devices with simple JavaScript code. This ensures that any changes made to learning suite content will be rendered immediately to any external websites using the JavaScript libraries requiring no human intervention.

A profiling service, for example using JavaScript, is used to provide personalization choices for the users. That is, a profiling system is used which associates a profile containing such information as, employee type, business unit, business role, interests, and other information, to each user. According to one embodiment, this profile is exposed as JavaScript on a Web page via a syndication service. For instance, the profiling service is invoked when the learning suite is used to automatically determine if a suite visitor is an executive, manager, seller, or technical leader. Accordingly, content appropriate for that role is displayed.

An end-user, or learner, simply uses a Web browser on his or her workstation or computer, or any other devices connected to the Internet, to access and use the learning suite. No other technology is needed. A content author uses a Lotus Notes client to write the content as easily as drafting an email.

In accordance with a further embodiment, replication technology is utilized so that the learning suite publication process is staged to ensure production is not affected by content writing. Replication is the process of synchronizing documents from the same databases on different workstations or servers over time. Replication enables exchanging modifications between special copies of databases called replicas. That is, replication allows the content author to enter and preview content on a “local” copy of the authoring database. When the content is ready for production, the changes can then be “replicated” to the production database.

An exemplary replication technology applicable in accordance with the invention is the Domino® replication technology developed by International Business Machines (IBM®). In accordance with the Domino technology, a Domino Directory is the central database in the Domino domain, and exists on every server in the domain. Likewise, there are other databases that Domino uses to function properly, such as the Certification Log and Administration Requests database, that need to be synchronized on all servers in the domain. A process called Domino Replication keeps the Domino Directory synchronized on all servers in the domain.

Additionally, users in the Domino environment use databases to collaborate and exchange information. These databases can reside on geographically dispersed servers and also need to be synchronized so all users have access to the same information.

Users can also rate suite content and request that it be sent to them directly, for example via e-mail. Rating suite content entails submitting a form to the Domino server containing the rating value and content identification. Additionally, measures are taken so users do not rate the same content more than once. For example, a “cookie” is used. A cookie is a piece of text that a Web server stores on a users hard disk. Cookies allow a Web site to store information on a user's machine and later retrieve it. The pieces of information are stored as name-value pairs. For example, a Web site might generate a unique identification (ID) number for each visitor and store the ID number on each user's machine using a cookie file.

Aggregated rating values are also displayed on the Web so that visitors can assess content quality. The values are also sent to content authors, for example, via their Lotus Notes clients or other e-mail service, so that they can assess what content is popular and what content needs editing.

Offline access is also provided in accordance with the invention. For example, one embodiment enables users to access the learning suite content offline, for example without requiring the user to view each suite or node page on their workstation or computer. For example, an interface is provided such that the Web user can display all of the suite pages chained together so that the entire suite is easily printed, e.g., removing the need to print many individual pages. Another option allows the user to request that the suite content be e-mailed to them. Authors can configure each suite so that either a rich-text representation of the pages is sent in the e-mail, or that a separate file (such as an Adobe Acrobat file) is sent in the e-mail.

The invention can take the form of an entirely hardware embodiment, an entirely software embodiment or an embodiment containing both hardware and software elements. For example, as illustrated in FIG. 2, at least one interface device 10 accesses database 20 which is located on server 30. Database 20 is where the learning suite or suites are located and the suites are generated and/or managed by subject matter experts 50. Further, the interface devices access the server 30 via the world-wide-web 60. A processing device such as microprocessor 40 provides an interface between the devices 10 and the server 30 as well as the subject matter experts 50.

In a further embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

It would be understood that a method incorporating any combination of the details mentioned above would fall within the scope of the present invention as determined based upon the claims below and any equivalents thereof.

Other aspects, objects and advantages of the present invention can be obtained from a study of the drawings, the disclosure and the appended claims.

What is claimed is:

1. A system for providing information about a particular topic to a user, the system comprising:
a database operably connected to the world-wide-web comprising informational content related to various topics;
an interface device operable to send and receive data from said database;
means for selecting, on said interface device, the particular topic from a plurality of available topics presented to the user on said interface device;
means for selecting a node from a plurality of nodes associated with the selected topic, wherein each node corresponds to different informational content related to the selected topic and the informational content corresponding to each node is from a different contextual basis; and
means for determining a learning level associated with the user, wherein the informational content associated with the selected node is different depending on the learning level of the user.

2. A system as claimed in claim 1, further comprising a server connected to the Internet and operable to store said database, wherein said server is located remote with respect to said interface device.

3. A system as claimed in claim 2, wherein said server comprises means for rendering the informational content located on the database in rich-text format.

4. A system as claimed in claim 2, wherein said server comprises means for rendering the informational content located on the database in hypertext markup language.

5. A method of providing informational content to a user, the method comprising:
compiling a database on a server, wherein the database includes informational content relevant to each of a plurality of different topics;
selecting a particular topic from the plurality of topics;
selecting a node from a plurality of nodes corresponding to the selected topic, wherein each of the plurality of nodes provides access to informational content on the database from a different contextual basis; and
providing informational content associated with the selected node to the user.

6. A method as claimed in claim 5, further comprising:
determining a level associated with the user; and
controlling the informational content provided to the user with respect to the selected node based on the level associated with the user.

7. A method as claimed in claim 5 further comprising managing the informational content on the database to ensure the informational content provided to the user is reliable.

8. A method as claimed in claim 5 wherein the different contextual bases from which information is provided with respect to the nodes includes at least one of, basic information, an expert's perspective, an on-the-job perspective, personal assessment and detailed information.

9. A method as claimed in claim 5 wherein the user is a member of an enterprise the members of which share a common business goal and informational content compiled into the database includes informational content generated exclusively by members of the enterprise.

10. A method as claimed in claim 5, wherein the informational content compiled on the database is in rich-text format.

11. A method as claimed in claim 5, wherein the informational content compiled on the database is in hypertext markup language.

12. A method as claimed in claim 6, wherein the level associated with the user corresponds to a particular job role of the user.

13. A method as claimed in claim 5, wherein at least a portion of the informational content compiled on the database utilizes Flash technology to render the informational content interactive with respect to the user.

14. A method as claimed in claim 5, wherein said selecting a node comprises:
activating a link on a Web-browser corresponding to a desired node;
accessing informational content located on the database based on the activated link; and
displaying a graphical representation of the informational content accessed on the database.

15. A method as claimed in claim 14 wherein said accessing informational content comprises searching the database for informational content tagged with an indicator, wherein the indicator is indicative that the tagged informational content is relevant to the selected node.

16. A method as claimed in claim 5, wherein said compiling the database comprises:
generating informational content relevant to at least one of the plurality of topics; and
tagging the generated informational content with at least one indicator, wherein each indicator corresponds to a different node to which the tagged informational content is relevant.

17. A method as claimed in claim 16 further comprising replicating informational content corresponding to the selected node from the database onto a device the user is using when the user selects the node.

18. A method as claimed in claim 5 further comprising:
rating the informational content provided from the database corresponding to the selected node, wherein the rating includes a value indicative of how valuable the informational content was to the user; and
providing the rating value to an author of the informational content.

19. A method as claimed in claim 5 further comprising:
downloading to a device used by the user, the informational content corresponding to all selected nodes; and
providing the downloaded informational content to the user in an integrated form.

20. A method as claimed in claim 5 wherein said providing informational content comprises sending an e-mail message to the user including the informational content.

21. A computer program product for providing informational content to a user, the program product comprising:
a computer readable medium;
first program instruction means for interfacing with a database on a server, wherein the database includes informational content relevant to each of a plurality of different topics;
second program instruction means for enabling a particular topic from the plurality of topics;
third program instruction means for enabling a node from a plurality of nodes corresponding to the enabled topic, wherein each of the plurality of nodes provides access to informational content on the database from a different contextual basis; and
fourth program instruction means for providing informational content associated with the enabled node to the user.

22. A computer program product as claimed in claim 21, further comprising:
fifth program instruction means for determining a level associated with the user; and
sixth program instruction means for controlling the informational content provided to the user with respect to the enabled node based on the level associated with the user.

23. A computer program product as claimed in claim 21, wherein the different contextual bases from which information is provided with respect to the nodes includes at least one of, basic information, an expert's perspective, an on-the-job perspective, personal assessment and detailed information.

24. A computer program product as claimed in claim 21, further comprising seventh program instruction means for rendering the informational content in rich-text format.

25. A computer program product as claimed in claim 21, further comprising eighth program instruction means for rendering the informational content in hypertext markup language.

26. A computer program product as claimed in claim 21, further comprising ninth program instruction means for rendering the informational content interactive with respect to the user using Flash technology.

27. A computer program product as claimed in claim 21, further comprising:
tenth program instruction means for activating a link on a Web-browser corresponding to a desired node;
eleventh program instruction means for accessing informational content located on the database based on the activated link; and
twelfth program instruction means for displaying a graphical representation of the informational content accessed on the database.

28. A computer program product as claimed in claim 21, further comprising thirteenth program instruction means for searching the database for informational content tagged with an indicator, wherein the indicator is indicative that the tagged informational content is relevant to the enabled node.

29. A computer program product as claimed in claim 21, further comprising fourteenth program instruction means for replicating informational content corresponding to the enabled node from the database onto a device the user is using.

30. A computer program product as claimed in claim 21, further comprising:
fifteenth program instruction means for downloading to a device used by the user, the informational content corresponding to all enabled nodes; and
sixteenth program instruction means for providing the downloaded informational content to the user in an integrated form.

31. A method of providing members of a particular business enterprise with learning materials relevant to the business enterprise, the method comprising:
developing the learning materials by recognized subject matter experts;
tagging a portion of the learning materials based on the subject matter of the portion as well as a level of relevance the portion has to individual jobs within the business enterprise;
continually updating the learning materials based on requirements of the members of the business enterprise;
storing the learning materials in a database on a server;
organizing the learning materials into at least one learning suite wherein the learning materials corresponding to each learning suite are related to a respective topic;
organizing the learning materials within each learning suite into at least one node, wherein the learning materials corresponding to each node provide a different respective contextual basis with respect to the corresponding topic.

32. A method as claimed in claim 31, further comprising:
a user selecting a particular learning suite from a plurality of learning suites;
the user selecting a particular node corresponding to the selected learning suite, wherein said selecting the particular node comprises choosing an icon from a web-page using a web-browser and linking to corresponding learning material within the database.

33. A method as claimed in claim 32, further comprising:
profiling the user based on information unique to the user, wherein the information unique to the user comprises at least information regarding a business role of the user within the business enterprise; and
providing learning material associated with the selected node to the user, based on a result of said profiling.
